(19) United States
(12) Patent Application Publication
(10) Pub. No.: US 2026/0167385 A1
(43) Pub. Date: Jun. 18, 2026

(54) COATING SYSTEM FOR CONTAINERS

(71) Applicant: SWIMC LLC, Cleveland, OH (US)

(72) Inventors: Jean-Dominique Turgis, Nantes (FR); Delphine Destal, Bouaye (FR); Clementine Maurier, Nantes (FR)

(21) Appl. No.: 18/707,657

(22) PCT Filed: Nov. 11, 2022
(86) PCT No.: PCT/US2022/079691

§ 371 Date: May 6, 2024

Related U.S. Application Data
(60) Provisional application No. 63/278,558, filed on Nov. 12, 2021.

(51) Int. Cl. B65D 25/14; C09D 7/40; C09D 7/62; C09D 127/06; C09D 133/04

(52) U.S. Cl. CPC B65D 25/14; C09D 7/62; C09D 7/68; C09D 7/69; C09D 127/06; C09D 133/04

(57) ABSTRACT

A packaging container, or a portion thereof, comprising a metal substrate, and an interior coating applied on at least a portion of the metal substrate. The interior coating formed from a coating composition including one or more film-forming binder resins and composite particles comprising one or more waxes and one or more inorganic sulfur-species scavenging component. The coating compositions protect closures or containers herein from corrosion due to at least sulfur or sulfur dioxide containing species.

### CROSS-REFERENCE TO RELATED APPLICATION

This application claims the benefit of U.S. provisional application No. 63/278,558 filed on Nov. 12, 2021, the entirety of which is hereby incorporated by reference.

### FIELD

The present application relates to coating systems for metal containers, and in particular, coating systems for metal containers configured to protect the containers from corrosion.

### BACKGROUND

The application of coatings to metals to inhibit corrosion is well established. This is particularly true in the area of packaging containers such as food or beverage containers and, in particular, for twist-off closures for such containers. For example, coatings are typically applied to the interior of containers to prevent the container contents from contacting any metal of the container. Contact between the container and the packaged product can, in some instances, lead to corrosion of the metal container or metal container part, which may be undesired for a variety of reasons. Protective coatings are also applied to the interior of closures for food or beverage containers, such as regular ends or easy-open ends, to prevent corrosion in the headspace of the container between the fill line of the food product and the container lid and/or to the inner surfaces of the container closing part. In such instances, container or closure corrosion may be a particular issue when the packaged contents are chemically aggressive in nature.

Packaging coatings should preferably be capable of high-speed application to the substrate and provide desired properties when hardened to perform in this demanding end use. For example, the coating should be safe for food contact, not adversely affect the taste of the packaged food or beverage product, have excellent adhesion to the substrate, resist staining and other coating defects such as “blushing” and/or “blistering,” and resist degradation over long periods of time, even when exposed to harsh environments. In addition, the coating should generally be capable of maintaining suitable film integrity during container and/or closure fabrication and be capable of withstanding the processing conditions that the container and closure may be subjected to during product packaging.

Conventional closures for packaging containers incorporate one or more coatings that are typically derived from physical and/or chemically curable formulations that often include one or more thermoplastic and/or thermosetting resins including, in some instances, vinyl chloride polymers such as polyvinylchloride (PVC) and/or epoxy-derived resins. When these coatings are applied to a substrate and cured, the coatings and/or the coated substrate can degrade and/or discolor under some circumstances. For example, the degradation products from PVC-based coatings or PVC-based gasket material may include hydrochloric acid that can attack and/or discolor the metal substrate forming the closure even with prior container coatings.

Additionally, sulfur containing food and beverage recipes can be particularly troublesome with metal containers, metal closures, and/or the coatings for such containers or closures. Sulfur dioxide, and/or sulfite ions therefrom may result from sulfur containing foods and often permeate through conventional protective coatings applied to such closures or containers to contact the underlying metal. The sulfur dioxide and/or sulfite also tends to be corrosive towards metals, especially iron or tin, that is commonly used to form conventional closures. Once in contact with the metal substrate, sulfur compounds can react with various species present on the metal surface and, combined with iron or tin, result in undesirable corrosion (e.g., bubbling, blistering, etc.) and/or unattractive dark spots or patches on the metal substrates of the container or closure. Such shortcomings have been found particularly problematic on the recently developed metal passivation pre-treatments that are hexavalent chromium-free.

### SUMMARY

In one embodiment, the present disclosure provides a metal substrate and an interior coating applied on at least a portion of the metal substrate. The interior coating is formed from a coating composition including one or more film-forming binder resins and composite particles comprising one or more waxes and one or more inorganic sulfur-species scavenging component.

In other embodiments, the metal substrate and interior coating of the preceding paragraph may be combined with one or more optional features or embodiments in any combination. The optional features or embodiments include one or more of: wherein the inorganic sulfur-species scavenging component includes zinc; and/or wherein the inorganic sulfur-species scavenging component includes a zinc oxide, a zinc aluminate, a zinc titanate, or a combination thereof, and preferably, includes a zinc oxide; and/or wherein the composite particles include a blend of the wax and the inorganic sulfur-species scavenging component; and/or wherein the wax has a solubility in water at 25° C. of less than 10 mg/liter, preferably less than 5 mg/liter, and more preferably, less than 1 mg/liter; and/or wherein the wax has a solubility in xylene at 50° C. of less than 1 g/liter, preferably less than 500 mg/liter, and more preferably, less than 100 mg/liter; and/or wherein the inorganic sulfur-species scavenging component has a solubility in water at a pH of 2 and at 25° C. of greater than 1 mg/liter; and/or wherein the metal substrate includes a metal substrate that has not been passivated using a hexavalent chromium containing composition; and/or wherein the metal substrate is pretreated with a pretreatment composition comprising a zirconium compound and one or more optional polymers (e.g., polyurea, polyester, acrylic, polyolefin, or combinations thereof); and/or wherein the metal substrate is part of a removable closure (e.g., twist-off closure); and/or wherein the one or more film-forming binder resins include polymers selected from polyester resins, polyether resins, acrylic resins, polyolefin resins, polyvinylchloride resins, derivatives thereof, or mixtures thereof; and/or wherein the coating composition is a powder coating composition or a liquid coating composition (e.g., an aqueous coating composition or an organic solvent-based coating composition); and/or wherein the wax is selected from (i) esters of fatty acids with fatty alcohols, fatty aldehydes, fatty triterpene alcohols, fatty steroid alcohols, or mixtures thereof; (ii) polyolefin waxes, (iii) fatty amides; (iv) metal esters of fatty acids; (v) derivatives thereof, or (vi) mixtures thereof; and/or wherein the molecules forming the wax have 16 or more carbons, preferably 35 or more carbons, more preferably 50 or more carbons, and even more preferably 100 or more carbons; and/or wherein the wax is selected from Carnauba wax, beeswax, rice bran wax, montan wax, paraffin wax, microcrystalline paraffin wax, polyethylene wax, polypropylene wax, Fischer-Tropsch paraffin wax, diketone wax, calcium stearate, magnesium stearate, zinc stearate, aluminum stearate, derivatives thereof, and mixtures thereof; and/or wherein the wax has a drop melting point of 60° C. to 250° C. as measured by ASTM D127, preferably, about 70° C. to about 200° C., and more preferably, about 80° C. to about 150° C.; and/or wherein the interior coating is a food-contact interior coating; and/or wherein the inorganic sulfur-species scavenging component has a distribution of particle sizes greater than 100 nm, preferably at least 150 nm, and more preferably, at least about 200 nm as measured by laser diffraction; and/or wherein the inorganic sulfur-species scavenging component has a distribution of particle sizes of about 2 microns or less, preferably, about 1.8 microns or less, and more preferably, about 1 microns or less as measured by laser diffraction; and/or wherein the inorganic sulfur-species scavenging component has a surface area of at least about 1 m²/g as determined by ASTM D3037, or preferably at least about 1 m²/g to about 50 m²/g, more preferably about 3 m²/g to about 50 m²/g, and even more preferably, about 10 m²/g to about 50 m²/g; and/or wherein the composite particles have a particle size ranging from a D10 at least about 0.3 microns to a D90 of about 15 microns or less, preferably a D10 of at least about 0.5 microns to a D90 of about 10 microns or less, and more preferably, a D10 of at least about 1 micron to a D90 of about 3 microns or less, and wherein the inorganic sulfur-species scavenging component is smaller than the size of the composite particles; and/or wherein the composite particles include at least about 30 weight percent of the inorganic sulfur-species scavenging component based on the total weight of the composite particles, preferably at least about 60 weight percent, and more preferably, at least about 70 weight percent; and/or wherein the composite particles include about 90 weight percent or less of the inorganic sulfur-species scavenging component based on the total weight of the composite particles, and preferably about 80 weight percent or less; and/or wherein the composite particles include at least about 10 weight percent of wax based on the total weight of the composite particles, preferably at least about 20 weight percent, and more preferably, at least about 25 weight percent; and/or wherein the composite particles include about 70 weight percent or less of wax based on the total weight of the composite particles, and preferably about 50 weight percent or less, and more preferably about 30 weight percent or less; and/or wherein the coating composition has a weight ratio of zinc to an amount of the composite particle; and/or wherein the coating composition, based on total nonvolatile weight, has at least about 0.01 weight percent of the inorganic sulfur-species scavenging component, preferably at least about 0.5 weight percent, and more preferably, at least about 1 weight percent; and/or wherein the coating composition, when dried as a coating on the interior surface of the substrate, has about 10 weight percent or less of the inorganic sulfur-species scavenging component, preferably, about 8 weight percent or less, and more preferably, about 5 weight percent or less; and/or wherein the coating composition, based on total nonvolatile weight, includes zinc provided by the inorganic sulfur-species scavenging component; and/or wherein the coating composition includes about 30 to about 65 weight percent total solids; and/or further including a first and a second coating applied to at least a portion of the interior surface of the substrate and wherein the coating composition is either the first coating, the second coating, or both the first and the second coating; and/or wherein one of the first coating, the second coating or both has a concentration of composite particles within a surface region of the respective dried coating greater than a concentration of composite particles within a central region of the respective dried coating; and/or wherein the first layer includes the composite particles; and/or wherein the first layer includes a polyester-based or polyether-based coating, and optionally one or more crosslinkers (e.g., a phenolic crosslinker); and/or wherein the second layer is a PVC organosol including a thermoplastic polyvinyl chloride (PVC) polymer, one or more stabilizers (for the PVC), and one or more crosslinkers (e.g., phenolic crosslinkers), and optionally one or more other binder polymers (e.g., acrylics, polyesters, and the like); and/or further including a sealing gasket; and/or wherein the sealing gasket is a polyvinylchloride-containing sealing gasket; and/or wherein the composite particles remain as a discrete particle within the interior coating after all thermal treatments; and/or wherein the interior coating, when dried and contacted with an aqueous test solution including 4 weight percent acetic acid, 0.5 weight percent sodium chloride, and 0.052 weight percent sodium metabisulfite and heated for 30 minutes at 100° C. and then stored at 35° C. for 7 weeks (while still contacting the aqueous test solution), the aqueous test solution has no more than 5 ppm of zinc from the inorganic sulfur-species scavenging component; and/or wherein the interior coating, when dried and contacted with an aqueous test solution including 4 weight percent acetic acid, 0.5 weight percent sodium chloride, and 0.052 weight percent sodium metabisulfite and heated for 30 minutes at 100° C. and then stored at 35° C. for 7 weeks (while still contacting the aqueous test solution) remains free of blistering; and/or wherein the interior coating, when dried and contacted with an aqueous test solution including 4 weight percent acetic acid, 0.5 weight percent sodium chloride, and 0.052 weight percent sodium metabisulfite and autoclaved for 30 minutes at 100° C. and then stored at 35° C. for 3 weeks (while still contacting the aqueous test solution) has a corrosion rating of 4 or less as defined herein; and/or wherein the interior coating, when dried and contacted with an aqueous test solution including 4 weight percent acetic acid, 0.5 weight percent sodium chloride, and 0.052 weight percent sodium metabisulfite and autoclaved for 30 minutes at 100° C. and then stored at 35° C. for 3 weeks (while still contacting the aqueous test solution) remains substantially white in color and/or has little to no color change (e.g., has a delta E of about 10 or less, about 5 or less, or about 1 or less); and/or wherein the coating composition, based on total nonvolatile weight, includes about 10 to about 20 weight percent polyester resin, about 0 to about 25 weight percent phenolic resin, about 0 to about 5 weight percent urea-formaldehyde resin, and about 0 to about 50 weight percent polyvinylchloride; and/or wherein the coating composition includes about 1 to about 20 weight percent of the composite particles; and/or wherein the coating composition includes about 30 to about 50 weight percent of total solids; and/or wherein the coating composition is substantially free of each of bisphenol A, bisphenol F, or bisphenol S, or any epoxides thereof; and wherein the coating composition is optionally substantially free of styrene; or wherein the coating composition does not contain any bisphenol A, bisphenol F, bisphenol S, epoxides thereof, or styrene or structural units derived from bisphenol A, bisphenol F, bisphenol S, epoxides thereof, or styrene; and/or wherein the wax is a bio-based material from renewable processes and/or prepared from natural or renewable biological resources; and/or wherein the packaging container or portion thereof, comprises a food or beverage can, or a food or beverage can end, or both; and/or wherein the composite particles are melt-blended composite particles.

In other embodiments, the present disclosure also relates to a coating composition of as described by any of the embodiments of this Summary.

Unless otherwise specified, the following terms as used herein have the meanings provided below.

The term “substantially free” when used with respect to a coating composition that may contain a particular compound means that the coating composition contains less than 1,000 parts per million (ppm) of the recited compound (corresponding to less than 0.1 wt. %) regardless of the context of the compound (e.g., whether the compound is mobile in the coating or bound to a constituent of the coating—e.g., as a structural unit of a polymer or other material). The term “essentially free” when used with respect to a coating composition that may contain a particular compound means that the coating composition contains less than 100 parts per million (ppm) of the recited compound regardless of the context of the compound. The term “essentially completely free” when used with respect to a coating composition that may contain a particular compound means that the coating composition contains less than 5 parts per million (ppm) of the recited compound regardless of the context of the compound. The term “completely free” when used with respect to a coating composition that may contain a particular compound means that the coating composition contains less than 20 parts per billion (ppb) of the recited compound regardless of the context of the compound. When the phrases “free of” (outside the context of the aforementioned phrases), “do not contain”, “does not contain”, “does not include any” and the like are used herein, such phrases are not intended to preclude the presence of trace amounts of the pertinent structure or compound which may be present but were not intentionally used, e.g., due to the presence of environmental contaminants. As will be appreciated by persons having ordinary skill in the art, the amount of a compound in an ingredient, polymer, formulation or other component typically may be calculated based on the amounts of starting materials employed and yields obtained when making such ingredient, polymer, formulation or other component.

The term “sealing composition” refers to a material applied to a coating system on an interior surface of a closure (such as, twist off lids or caps) for purposes of helping to seal the closure to a container. In some embodiments, a sealing composition also is referred to as a gasket compound or a gasketing compound or a sealing compound because the sealing composition is used to form a gasket on the coating system. In a typical mode of practice, the sealing composition is applied as a fluid composition onto the coating system in order to form a gasket precursor. The precursor is then dried, crosslinked, and/or otherwise chemically and/or physically cured to form a gasket.

The term “organosol” refers to a dispersion of organic particles, e.g., particles comprising one or more thermoplastic resins (e.g., PVC particles) optionally in combination with one or more other ingredients or reaction products thereof, in a liquid carrier that includes an organic solvent, and is typically an organic-solvent based liquid carrier (as opposed to a water-based liquid carrier). In addition to solvent, the liquid carrier may incorporate one or more other optional ingredients, e.g., at least one plasticizer, surfactant, etc.

The term “resin” means an oligomer and/or polymer. Oligomers or polymers may include polymerizable functionality that allows the resin to be further polymerized, cross-linked, or otherwise reactive as desired. The term “oligomer” means a compound incorporating from two to ten repeating units. The term “polymer” means a compound incorporating 11 or more repeating units. Repeating units typically are derived from one or more monomers. A “monomer” generally includes at least one polymerizable moiety and generally constitutes a single repeating block when incorporated into an oligomer or polymer. A monomer may be incorporated into oligomers or polymers via co-polymerization with itself or with one or more other kinds of monomers, oligomers, and/or polymers. Non-polymerizable terminal moieties, e.g., a monoalcohol or alkoxy group with no additional reactive functional group, are not considered repeating units for purposes of the present invention. Polymers often have number average molecular weights in the range from about 1,000 to 1,000,000 (or more) or even from about 2,000 to about 250,000, or even from about 2,000 to about 50,000, or even 3,000 to 25,000.

The term “polymer” includes both homopolymers (repeating units are derived from the same monomer) and copolymers (i.e., polymers of two or more different monomers). Similarly, “oligomer” includes both homo-oligomers and co-oligomers.

The term “crosslinker” refers to a molecule capable of forming a covalent linkage between two or more resins or between two or more different regions of the same resin. Some embodiments of crosslinkers may be resins. A resin may be a crosslinker for one or more other resins or resin precursors. A resin may be a crosslinker that is self-crosslinking.

The terms “comprises”, “having”, “including”, “incorporating”, and variations thereof do not have a limiting meaning where these terms appear in the description and claims but rather are intended to be open-ended.

The terms “preferred” and “preferably” refer to embodiments of the invention that may afford certain benefits in some modes of practice. However, other embodiments may also be preferred or otherwise suitable, under the same or other circumstances. Furthermore, the recitation of one or more preferred embodiments does not imply that other embodiments are not useful, and such recitation is not intended to exclude other embodiments from the scope of the invention.

As used herein, “a,” “an,” “the,” “at least one,” and “one or more” are used interchangeably. Thus, for example, a coating composition that comprises “an” amine can be interpreted to mean that the coating composition includes “one or more” amines.

Also herein, the recitations of numerical ranges by endpoints include all numbers subsumed within that range (e.g., 1 to 5 includes 1, 1.5, 2, 2.75, 3, 3.80, 4, 5, etc, and at least 1 includes 1, 1.03, 1.5, 2, 17, etc.).

### DETAILED DESCRIPTION

The details of one or more embodiments of the present disclosure are set forth in the description below and the summary above. Other features, objects, and advantages will also be apparent from the summary above and the description and the claims that follow. The following description is not intended to describe every implementation of the novel discoveries herein. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list. The disclosure herein will first generally describe the container, closure, and coating systems thereof and, then more specifically describes various aspects of the container, closure, and coating systems.

In general, the present disclosure provides a packaging container, or a portion thereof (e.g., a removable closure for a packaging article or container), one or more coatings and/or a coating system including such coatings applied on at least a portion of an interior surface of a substrate (e.g., a metal substrate) forming the container or closure, coating compositions useful to form the coatings or coating systems for the container or closures herein, the resultant coating systems, and/or associated methods of making such closures, coatings, systems, and packaging articles or closures thereof. The coating compositions herein are preferably applied directly (i.e., the coating composition directly contacts the substrate) or indirectly (i.e., there is one or more intervening layers between at least a portion of the coating composition and at least a portion of the substrate) to the desired metal substrate to form a coating at least proximal to the substrate. Advantages of the resultant coatings and coating systems herein is that, among other features, they show excellent adhesion to both a metal substrate and to gasket material, show excellent chemical resistance to items such as acidic food and beverage materials as well as sulfur-containing and/or sulfur-releasing food or beverage materials, and/or show excellent corrosion and/or stain resistance in such contexts.

In one approach, the coating compositions for the coating systems herein generally include ingredients comprising one or more film-forming binder resins and composite particles comprising one or more waxes and one or more inorganic sulfur-species scavenging components. The coating compositions may be a powder coating composition or a liquid coating composition (such as an aqueous coating composition or an organic solvent-based coating composition). In approaches, the coating compositions may preferably include no more than a de minimus amount of water, such as less than about 2 wt-%, less than about 0.5 wt-%, or less than about 0.1 wt-%, if any water.

As discussed more below, the composite particles of the coating compositions provide a particulate matter that protect the closures or containers herein from corrosion due to at least sulfur or sulfur dioxide containing species. The composite particle in general includes one or more waxes that may be any organic wax-based material incompatible and/or insoluble with the one or more binder resins. As such, in preferred embodiments, the composite particles herein remain as discrete particles within the formed coating layer(s) after all coating, drying, and/or baking steps are completed. In approaches, the inorganic sulfur-species scavenging component of the composite particles herein may be any inorganic material capable of reacting with or entrapping sulfur dioxide or derivatives thereof, such as sulfite ions, and may, in some approaches, be selected from a zinc oxide, a zinc aluminate, a zinc titanate, zinc chromate, other mixed oxides or combinations thereof, and preferably, with a zinc oxide being particularly preferred. In yet other approaches, the binder resins for the coating compositions herein are not particularly limited and the one or more film-forming binder resins may include one or more film-forming polymers or copolymers selected from, but not limited to, epoxies (or polyethers), polyesters, polyolefins, halogenated polyolefins such as polyvinyl chloride (“PVC”) particles and/or PVC solutions vinyls, phenolics, alkyds, oleoresins, acrylics, and the like resins and binders.

The metal used to form the substrates of the closures and/or containers herein could be subjected to one or more pre-treatment steps by the manufacturer of the metal sheet used to form the substrate. In some instances, there are chemical pretreatments such as one or more pretreatment composition applied to the metal via, for example, spraying or dipping. For example, in some instances, the metal substrate is pretreated with a pretreatment composition comprising a zirconium compound and one or more polymers selected from polyester, acrylic, polyolefin, or combinations thereof. These pre-treatments may deposit one or more, often relatively thin layers on the metal substrate (e.g., less than 1 micron in thickness). Such layers may be organic, inorganic, or combinations of these. Such pre-treatment layers are considered to be part of the metal substrate. In some instances, the metal used to form the substrates herein are hexavalent chromium-free or so-called CFPA substrates (chromium-free-passivation alternative or electrolytic zirconium passivation (EZT) or trivalent chromium-coating technology (TCCT)) that include metal substrates substantially free, essentially free, or completely free of any pretreatments including hexavalent chromium (see, e.g., US 2022/0154360 A1 and patent references described therein, which are all incorporated herein by reference). CFPA metal substrates herein may be defined by DIN EN10202. Suitable pretreatments may be described in CA 2,166,331; U.S. Pat. No. 5,427,632; or WO 9504169, which are all incorporated herein by reference.

The containers, portions thereof, or closures herein generally have an interior and an exterior surface, and the coating compositions of the present disclosure are useful, in various embodiments, as monocoat or multilayer coating systems applied on the interior surfaces. In illustrative modes of practice, the features of the coating compositions described herein (that is at least the binder resins and composite particles) can be used within a first or base layer/coating applied directly to the metal substrate (e.g., a metal substrate that has been subjected to one or more pretreatments such as those discussed in the preceding paragraph). This first base coating also may be referred to as a size coating or a primer coating. In other instances, the coating compositions herein may also include ingredients (that is at least the binder resins and composite particles) useful within a second coating applied directly or indirectly to the first coating to form a second coating layer from the substrate. The second coating may be referred to as a topcoat, top coat, or top coating even though one or more additional, but optional coatings and/or other materials, such as a sealing composition, may be further applied to at least a portion of the second coating. Although the coating systems may optionally include additional layers, some preferred embodiments of a multilayer coating system comprise and/or consist essentially of the first coating and the second coating optionally used in combination with a sealing or gasket compound described more below. In other illustrative modes of practice, the ingredients forming the coating compositions herein (that is binder resins and composition particles) can be used as a coating forming the base layer, the top coating, or both.

In some particular embodiments, the composite particles are included in one or more layers of a multi-layer coating system. Examples of such multi-layer system include interior closure coating systems or food-easy-open can end interior coating systems such as those described, for example, in U.S. Pat. Nos. 8,142,858, 8,574,672, 10,516,502, U.S. Publ. No. 2016/0221733, and U.S. Publ. No. 2017/0137665. In such systems, typically the base layer (often referred to as a “size” or “primer” coat) is a polyester-based or polyether-based coating, and typically including one or more crosslinkers such as a phenolic crosslinker. The top-coat layer is often a PVC organosol that typically includes a thermoplastic polyvinyl chloride (PVC) polymer, one or more stabilizers (for the PVC), and one or more crosslinkers (e.g., phenolic crosslinkers), and optionally one or more other binder polymers (e.g., acrylics, polyesters, two-coat systems without PVC, and the like).

In some embodiments, the composite particles are included in a mono-layer closure coating system. An example of such a closure coating system is described in U.S. Pat. No. 10,486,865, which described embodiments that substantially free of polyvinyl chloride. An example of a mono-layer PVC organosol is described in U.S. Pat. No. 7,682,674.

In many embodiments, a sealing composition may be applied to at least a portion of the coating system in a manner effective to form a gasket that enhances the seal between the closure and a container (e.g., a glass jar). In some embodiments, the sealing composition is provided in the form of an annular gasket adhered directly or indirectly to the coating system or the container in a manner such that the gasket sealingly engages the container or closure (as the case may be), such as engaging a rim (e.g., a rim of a glass jar), when the closure is fit onto the container.

The coating compositions disclosed herein may be used on many types of packages or containers and contact many different types of packaged products. Examples of food or beverage products often packaged in such packages or containers may include certain acid-based food or beverages, milk-based products, meat-based products, onions, sauerkraut, fish in sauce, marinades, mussels, fruits in sweet sauces, energy drinks, coffee drinks, soups, mustard, mayonnaise, ketchup, salad dressings, pickled vegetables, sauerkraut, and the like. The coating compositions disclosed herein may be used to coat interior surfaces of containers or container parts (e.g., closures) for contacting such food or beverage products, including coatings suitable for long-term contact with products having challenging sulfur-containing species associated therewith. The coating compositions disclosed herein may also be used to protect interior surfaces of packaging for non-food products, such as but not limited to, hair spray, hair dye, paints and stains, joint compound, concrete mixes, glue, cleaning compositions, etching compositions, pharmaceuticals, nutraceuticals, fertilizers, and the like. Exemplary packaging on which the coating compositions disclosed herein may be used (e.g., as an interior coating) include, but are not limited to, cans such as beverage cans, drums, kegs, pails, decorative tins, tubes, bottles, jars, monoblocs, closures, and the like. Exemplary closure devices include, but are not limited to, caps, lids such as thin aluminum foil based lids for yogurt and butter containers, or crown corks; closures for glass jars and bottles such as roll-on closures, vacuum closures, twist on/off lids, pilfer-proof closures, easy peel lids, and easy open end or conventional ends for cans. Cans on which the closures of the invention can be used include, for example, 2-piece cans or 3-piece cans or glass jars. Beverage cans include, but are not limited to, beer cans, carbonated soft drink cans, energy drink cans, isotonic drink cans, water cans, juice cans, tea cans, coffee cans, milk cans, and the like. Food cans, include, but are not limited to, vegetable cans, fruit cans, meat cans, soup cans, ready meal cans, fish cans, edible oil cans, sauce cans and the like. The coating compositions herein may be used on any part of the packaging container surfaces and for example, may be applied to surfaces other than closures such as the coating the insides of certain food and beverage cans that do not have a closure.

The coated packaging containers (e.g., food or beverage cans) or portions thereof (e.g., closures) of the invention may be formed via any suitable method. The coating compositions of the present invention may, for example, be applied to and at least partially cured on a substrate material, such as a metal sheet, coil, foil or the like. Next, the coated substrate may be formed into the final closure shape (or other container part shape) via the desired technique(s). Illustrative embodiments of the coating system are sufficiently flexible to allow shaping after the cured coatings are formed. If the coating is partially cured at the time the closure (or other container part) is shaped, the coating may be more completely cured after shaping.

In preferred embodiments, the cured protective coating system exhibits not only good flexibility, but also excellent chemical resistance, stain resistance, blush resistance, color resistance, and the like especially in the presence of foodstuffs containing sulfur, and/or acetic acid, and/or citric acid and/or lactic acid, and without exhibiting undue loss of adhesion. In the alternative, a substrate may be formed into a closure (or any other packaging article or portion thereof disclosed herein), and then the closure (or other packaging article or portion thereof disclosed herein) may be coated with the coating composition system. The substrate or coated substrate (as the case may be) used in the closure (or other packaging article or portion thereof disclosed herein) may be formed via stamping, drawing, redrawing, wall ironing, bending, beading, embossing, debossing, flanging, necking, stretching, blow-stretching, and any other suitable conventional method.

In one aspect, the present disclosure provides a rigid metal closure, such as a twist-off metal lid which may include fastening features such as lugs or threads, for use in sealing a food or beverage packaging container. Such packaging or containers often include a glass or plastic jar or bottle configured to receive the threads, lugs, or other engagement structure of the closure. The metal closure preferably includes a coating system of a monocoat or multilayer coating as described herein applied on at least a portion of an interior surface (that is, food-facing or beverage-facing surface) of the metal closure as a food-contact coating. In one embodiment, a first layer composition forms a first coating adhered to the metal substrate and a second layer composition forms a second coating adhered to the first layer composition. As previously discussed, often the surface of the metal substrate (e.g., steel, aluminum, and the like) has been treated with a pretreatment composition (e.g., a chromium-containing or chromium-free pretreatment composition such as any of those disclosed herein) such that pretreatment composition is present on the surface of the metal substrate. Optionally, sealing composition (which may, e.g., be either a conventional PVC-based sealing compound or a PVC-free sealing compound) may be applied directly to the second composition. In one embodiment, the closure is formed from metal sheet having the coating system cured on at least one side thereof.

The metal substrates forming the closures and other containers or portions thereof herein can be formed from wide range of materials. Such materials include metallic materials, polymeric materials, combinations of these, and the like. In many modes of practice, the substrate includes one or more metallic materials such as metals, metal alloys, intermetallic compositions, metal containing composites, combinations of these, and the like. Metallic embodiments of the substrate may comprise one or more metals including, but not limited to, aluminum and aluminum alloys, tinplate, cold rolled low carbon mild steel (“ETP”), electrolytic chromium/chromium oxide coated cold rolled low carbon mild steel (ECCS), tin-free steel, black plate, corten steel, and any other steel.

The substrate may comprise one or more layers. Each layer may have a thickness in the range of from 0.01 μm (micrometer) to 2 mm (millimeter); for example, from 0.01 μm to 1.5 mm; or in the alternative, from 0.01 μm to 1 mm; or in the alternative, from 0.01 μm to 0.5 mm; or in the alternative, from 0.01 μm to 0.2 mm; or in the alternative, from 0.01 μm to 0.1 mm or in the alternative, from 0.01 μm to 100 μm; or in the alternative, from 0.01 μm to 50 μm; or in the alternative, from 1 μm to 50 μm; or in the alternative, from 1 μm to 15 μm.

In addition to the coating system, the substrate optionally may be pre-coated with one or more pre-treatment compositions, which are considered part of the substrates for purposes of the disclosures herein. Such pre-coating compositions optionally may include, but are not limited to, one or more resin binders, one or more resin crosslinkers, one or more solvents, one or more additives, and one or more pigments. Exemplary resin binders include, but are not limited to, epoxy, polyester, polyvinyl chloride containing organosols/vinyls, phenolic, alkyd, oleoresin, acrylic resin, and the like. As mentioned above, the metal substrates, in one embodiment, are chromium-free or CFPA substrates (chromium-free-passivation alternative) that include metal substrates substantially free, essentially free, or completely free of any pretreatments including chromium such as hexavalent chromium

The disclosure will now turn to more specifics of the coating composition, container, and/or closure therefor.

### Wax or Wax Derivative of the Composite Particles

In embodiments, the wax or wax derivative the composite particles herein is any organic material that is insoluble with the one or more binder resins of the coating compositions such that the composite particles remain as discrete particles, phases, or domains within a formed coating after all coating, drying, and/or baking steps are completed. In some such embodiments, or other approaches, the wax or wax derivative remains insoluble in water and/or organic solvents. For wax solubility purposes, xylene may be used as a representative of such solvents. In this context, insoluble refers to a solubility of the wax in water at 25° C. of less than 10 mg/liter, preferably less than 5 mg/liter, and more preferably, less than 1 mg/liter, and/or a solubility of the wax in xylene at 50° C. of less than 1 g/liter, preferably less than 500 mg/liter, and more preferably, less than 100 mg/liter. The aforementioned solubility ranges include zero—that is, no trace amount of solubility is required.

In some embodiments, a suitable wax for the composite particles may be, in general, any organic material that is largely lipophilic with a melting point of at least about 40° C. and that is insoluble in water and only sparingly soluble in organic and/or nonpolar solvents (as defined above). In some approaches, suitable waxes are organic compounds of aliphatic alkyl chains (at least 10 or more carbons and, in some instance, up to 30 or more carbons), although aromatic substitution may also be present in some forms of the wax. In other approaches, exemplary waxes may contain unsaturated bonds and include various functional groups, such as fatty acids, alcohols, ketones, aldehydes and/or fatty acid esters, and the like as needed for a particular application or functionality. Waxes may be natural or synthetic, and synthetic waxes may include aliphatic hydrocarbons (alkanes or paraffin)

In other approaches, a wax or wax derivative for the composite particles herein may be selected from (i) esters of fatty acids with fatty alcohols, fatty aldehydes, fatty triterpene alcohols, fatty steroid alcohols, or mixtures thereof; (ii) polyolefin waxes, (iii) fatty amides; (iv) metal esters of fatty acids; (v) derivatives thereof, or (vi) mixtures thereof. The compounds or molecules forming the wax or wax derivative may have 16 or more carbons, preferably 35 or more carbons, more preferably 50 or more carbons, and even more preferably 100 or more carbons. The upper end of carbons in the wax compound or molecule is not particularly limited, but may be 500 or less, 400 or less, 200 or less, or 150 or less carbons. In approaches, suitable waxes or derivatives thereof may have a drop melting point of about 60° C. to about 200° C. as measured by ASTM D127, preferably about 65° C. to about 200° C., and more preferably, about 70° C. to about 150° C.

Exemplary waxes or derivatives thereof that may be used for the composite particles herein include, but are not limited to, Carnauba wax, beeswax, rice bran wax, montan wax, paraffin wax, microcrystalline paraffin wax, polyethylene wax, polypropylene wax, Fischer-Tropsch paraffin wax, diketone wax, calcium stearate, magnesium stearate, zinc stearate, aluminum stearate, derivatives thereof, or mixtures thereof. In some approaches, the wax may be substantially free-of and preferably free-of any per- and/or poly-fluoroalkyl substances (PFAS). In preferred embodiments, the waxes herein are also preferably free of fluorine components or fluorine substituents. In yet other approaches, any of the waxes herein may be a bio-based material that is bio-sourced or bio-derived and may include non-petrochemical-based materials. In other approaches, the bio-based materials may be sourced from renewable processes and/or prepared from natural or renewable biological resources.

In approaches, suitable wax materials are preferably resistant to water, salts and the various acids founds in food and beverages within the containers, but the materials for the wax are otherwise substantially permeable to sulfur-containing gases such as SO₂ or H₂S and the like.

In some optional approaches, the selected wax of the composite particles herein enables the particles, in some optional circumstances, to migrate (at least in part) to a coating interfaces (that is, a top or bottom surface area or surface region of a coating or coating layer) during the drying, curing or baking process of the coating. Such migration allows the composite particles to accumulate at the interface or surface region, creating interfacial layers or zones of a coating enriched in the composite particles. This migration may be advantageous in the coatings herein because the enriched layers or zones may provide an enhanced filter for entrapping or reacting with the undesired gaseous species like SO₂ or H₂S. This migration effect may also help reducing the overall amount of particles used and therefore the risk of later migration of any metal ions into the food from the coatings herein. Thus, the cured coatings herein may have an enrichment or a concentration of the composite particles at a coating interface or at least within a surface region of a dried coating that is greater than a concentration of the composite particles within a central region (e.g., substantially diffused throughout therein) of the respective dried coating.

As used herein, a coating interface or surface region of a cured coating generally refers to an area or region that has a relative thickness generally extending perpendicularly from the surface of the cured coating to a depth of less than about 0.5 microns beneath a top surface of a respective coating such as, for example, an average such depth of about 0.2 to about 0.5 microns. The interface or surface region enriched with the composite particles may be compared to the central region that has less of the composite particles relative to the interface or surface region. As used herein, the central region of any cured composition generally refers to another portion of the coating layer which extends beneath the surface region/interface noted above.

The concentration of composite particles in either the surface region/interface relative to the central region of a cured coating can be characterized in a variety of ways including, but not limited to, a particle density such as an average number density of particles (for instance, the average number of particles per unit volume) in the surface region being greater than the average number density in the central region. The concentration of particles in a region of a cured coating can be determined, for instance, by a variety of surface analysis techniques known in the art including Transmission Electron Microscopy (TEM), Scanning Electron Microscopy (SEM), Atomic Force Microscopy (AFM), and/or X-ray Photoelectron Spectroscopy, and the like techniques.

In some optional approaches, the wax may be a material or melt-blend of materials that could be produced in-situ during the coating, baking, or closure forming process from originally substantially pure and separated ingredients included within a particular coating composition. For example, wax blends may be formed from individual waxes included in the various coating compositions from the composite particles and or other optional wax ingredients within the composition by way of solubility, melting, melt-blending, and/or co-melting during the manufacturing, storage, drying, curing, baking of the full coating composition, or by wet chemistry within the baked coating during the autoclaving steps of the fabricated packaging element. Such involuntary but naturally produced blends and/or so-called alloys of materials, such as the waxes of the carrier matrix, may be contemplated by the composite particles and wax components thereof.

In any embodiment or approach herein, the composite particles may include at least about 10 weight percent of the wax or wax derivative based on the total weight of the composite particles, preferably at least about 20 weight percent, and more preferably, at least about 25 weight percent of the wax or wax derivative. In other embodiments, the composite particles include about 70 weight percent or less of wax or wax derivative based on the total weight of the composite particles, and preferably about 50 weight percent or less, and more preferably about 30 weight percent or less of the wax or wax derivative.

### Sulfur-Species Scavenging Components

The composite particles herein further include one or more inorganic materials, and preferably, inorganic materials capable of scavenging sulfur-species or sulfur components such as sulfur dioxide or derivatives thereof, such as sulfite ions. The inorganic sulfur-species scavenging components may be any inorganic material effective to scavenge such sulfur compounds such as sulfur compounds that migrate from a food or beverage through the closure coatings. In embodiments, the activity of such inorganic substance hinders, and in some instances, prevents the sulfur from interacting with and/or contacting the metal substrates of the closures or other packaging articles herein. Without wishing to be limited by theory, the scavenging activity of the inorganic substances may be the particular inorganic metal reacting with the sulfur substance and/or crystalline forms of the inorganic substance entrapping or adsorbing the sulfur compounds.

In some approaches, the inorganic substance of the sulfur-species scavenging component includes zinc, and preferably, the inorganic sulfur-species scavenging component includes a zinc oxide, a zinc aluminate, a zinc titanate, or a combination thereof, and preferably, includes a zinc oxide. In optional approaches, the inorganic substance may be doped with various other metals and/or metal oxides in order to direct the effectiveness of interactions with sulfur-containing gases like SO₂ or H₂S. Such doped oxides, for instance a potassium-doped zinc oxide may also be used as needed for a particular application. In the context of the inorganic substance being zinc oxide, for instance, the scavenging activity may be the zinc oxide reacting with the sulfur or sulfite ion to yield zinc sulfide. Optionally, a microporous structure of the inorganic material, such as a zinc oxide, may further entrap or absorb the sulfur compounds within the particle structure of the inorganic substance.

In some approaches, the inorganic substance for the sulfur scavenging component is a particulate material with a high surface area, such as small particles and/or particles having a tortuous or porous microstructure. As noted above, the inorganic substance may be concentrated or arranged within the coating into a thin and concentrated protective layer, in some approaches, the furthest possible away from the metal interface (i.e., near and/or at the coating surface). In some embodiments, the inorganic substance for the sulfur scavenging component may have a distribution of particle sizes greater than 100 nm, preferably at least 150 nm, and more preferably, at least about 200 nm as measured by laser diffraction. In other approaches, the inorganic sulfur-species scavenging component has a distribution of particle sizes smaller than the diameter of the composite particles, and in some instance, a particle size distribution of about 2 microns or less, preferably about 1.8 microns or less, and more preferably about 1 microns or less as measured by laser diffraction. The inorganic substance may also have a high surface area of at least about 1 m²/g as determined by ASTM D3037, preferably at least about 3 m²/g, and more preferably at least about 10 m²/g to about 50 m²/g. Although the upper surface area is not restricted, typically the inorganic substance will have a surface are of 50 m²/g or less as determined by ASTM D3037. Thus, in some embodiments, the inorganic substance has a surface of at least about 1 m²/g to about 50 m²/g, preferably at least about 3 m²/g to about 50 m²/g, and more preferably at least about 10 m²/g to about 50 m²/g, as determined by ASTM D3037. The aforementioned surface area is conveniently measured for the inorganic substance feedstock prior to formation of the composite particles, or, in some instances, is supplied by the supplier and/or manufacturer of the inorganic substance or composite particles.

The particle sizes referred to herein may be determined by laser diffraction particle size analysis using a Beckman Coulter LS 230 Laser Diffraction Particle Size Analyzer or equivalent, calibrated as recommended by the manufacturer. Particle size distribution and/or the particle size “D-values” (e.g., D10, . . . . D50, D90, D95, and D99) are the particle sizes which divide a sample's volume into a specified percentage when the particles are arranged on an ascending particle size basis. For example, for particle size distributions the median is called the D50 (or x50 when following certain ISO guidelines). The D50 is the particle size in microns that splits the distribution with half above and half below this diameter. The Dv50 (or Dv0.5) is the median for a volume distribution. The D90 describes the particle size where ninety percent of the distribution has a smaller particle size and ten percent has a larger particle size. The D95 describes the particle size where ninety five percent of the distribution has a smaller particle size and five percent has a larger particle size. The D99 describes the particle size where ninety nine percent of the distribution has a smaller particle size and one percent has a larger particle size. Unless specified otherwise herein, D50, D90, D95, and D99 refer to Dv50, Dv90, Dv95, and Dv99, respectively. The D-values specified herein may be determined by laser diffraction particle size analysis.

Samples for laser diffraction particle size analysis can be prepared, for example, by diluting the samples in a substantially non-swelling solvent (such as cyclohexanone or 2-butoxyethanol) and shaking them until evenly dispersed. The choice of a suitable solvent will depend upon the particular particles to be tested. Solvent screening tests may need to be conducted to identify a suitable substantially non-swelling solvent. By way of example, a solvent in which a polymer particle swells by about 1% or less (as determined by laser diffraction particle size analysis) would be considered a substantially non-swelling solvent.

In embodiments, the inorganic sulfur-species scavenging component is also soluble in water, and in this context, soluble refers to the scavenging component (such as those described above) having a solubility in water at a pH of 2 and at 25° C. of greater than 1 mg/liter. In other embodiments, the scavenging component may have a solubility in water about 1 mol/liter at pH below 7 or about 10³ mol/liter below pH 5.

In other embodiments, the composite particles herein may include at least about 30 weight percent of the inorganic sulfur-species scavenging component based on the total weight of the composite particles, preferably at least about 60 weight percent, and more preferably, at least about 70 weight percent. In other embodiments, the composite particles may include about 90 weight percent or less of the inorganic sulfur-species scavenging component based on the total weight of the composite particles, and preferably about 80 weight percent or less. The coating composition, based on total nonvolatile weight, has at least about 0.01 weight percent of the inorganic sulfur-species scavenging component, preferably at least about 0.5 weight percent, and more preferably, at least about 1 weight percent.

### Composite Particles

The composite particles include the above-described inorganic scavenging material and the wax. Preferably, the amount and size of the inorganic material relative to the amount of wax and overall composite particle size results in the composite particles having limited to substantially no amount of inorganic material present or exposed on the surface of the composite particles. To this end, the composite particles are preferably about 30 to about 90 weight percent of the inorganic substance based on the total weight of the composite particles, more preferably about 50 weight percent to about 80 weight percent, and even more preferably, about 70 weight percent to about 80 weight percent. The composite particles may also be about 10 to about 70 weight percent wax, preferably about 20 to about 50 percent wax, and more preferably, about 20 to about 30 percent wax. In such forms, the inorganic material may be substantially encapsulated and/or embedded within the organic carrier matrix with little to no inorganic material exposed on the surface of the particles.

The composite particles have an average particle size larger than the average particle size of the inorganic materials. Preferably, the composite particles are present in a particle size distribution having a D50 (and preferably a D90) of less than about 15 microns, preferably less than about 10 microns, even more preferably less than 5 microns, and even more preferably less than about 3 microns. In approaches, the composite particles herein have a particle size distribution ranging from a D10 at least about 0.3 microns to a D90 of about 15 microns or less, preferably a D10 of at least about 0.5 microns to a D90 of about 10 microns or less, and more preferably, a D10 of at least about 1 micron to a D90 of about 3 microns or less, and wherein the inorganic sulfur-species scavenging component is smaller than the size of the composite particles. Particle size may be determined using the techniques as discussed above. In some embodiments, the D90 of the composite particles is smaller than a dried thickness of the coating such that no surface of the particles is exposed or substantially exposed outside of the coating.

In yet other approaches, the amount of metal (e.g., zinc and, in particular zinc (2+)) provided by the composite particles herein is such that the coating compositions, when dried, have about up to about 10 weight percent of the metal oxide, up to about 8 weight percent of the metal oxide, up to about 6 weight percent, or even up to about 4 weight percent of the metal oxide and preferably, about 0.01 to about 10 weight percent of the metal oxide or other ranges within the above noted amounts, and more preferably, about 0.1 to about 5 weight percent as measured on a non-volatile portion of the coating composition. As noted previously, the concentration of metal may be enriched at the interface and/or surface regions of a particular coating layer.

The composite particles may be prepared using any known techniques for encapsulating or embedding particulate within a carrier matrix. In one approach, the composite particles may be formed by spray drying, precipitating, cryogenic freezing, micronizing, and the like techniques from a medium including an admixture of the particular inorganic substance and the carrier matrix. Suitable mixing, extrusion, co-extrusion techniques may be used to blend the inorganic substance and the organic carrier matrix. If needed, the admixture of the materials used to form the composite particles may further include other additives or ingredient such as emulsifiers, wetting agents, antioxidants, stabilizers, neutralizing agents, catalysts, thickeners, dispersants, biocides or the like, and mixtures thereof depending on the particular applications and/or circumstances of the blending and mixing.

### Coating Compositions:

As noted above, the coating compositions herein include at least one or more film-forming binders or resins that may include suitable film-forming polymers or copolymers. In one approach, exemplary resin binders include, but are not limited to, polymers or copolymers selected from epoxy (also often referred to as “polyether” polymers), polyester, halogenated polyolefins such as polyvinyl chloride containing organosols/vinyls, phenolic, alkyd, oleoresin, acrylic, polyolefin, and the like resins and binders, copolymers thereof (e.g., polyester-acrylate copolymers, polyester-urethane copolymers, polyether-acrylate copolymers, and the like), and mixtures thereof. While the amount of binder resin is not particularly limited, the compositions may include, in some approaches, greater than about 50 weight percent of the binder resin(s), based on total solids in the compositions.

Exemplary polyolefin binder resins may include structural or monomer units derived from two or more C2 to C12 alpha olefins and may include other optional structural units and/or other optional binder resins as needed for a particular application. In some such approaches, the polyolefin polymer is derived from ethylene and one or more C3-C12 alpha-olefins and, in one example, includes ethylene structural units (or ethylene monomer moieties) as well as C3 to C12 structural units (or C3 to C12 monomer moieties), and in particular, ethylene and propylene. As used herein, an ethylene structural unit (or monomer moiety) generally refers to a —H₂C—CH₂-unit within a copolymer chain, which is derived from an ethylene molecule or reactant during copolymerization, with a similar definition applying to C3-C12 alpha-olefin structural units (or monomer moieties). As used herein, an olefin may also generally refer to a family of organic compounds that are alkenes with a chemical formula CₓH₂ₓ, where x is the carbon number and having a double bond within its structure.

Exemplary polyester binder resins may be thermoplastic or thermosetting resins that include at least one ester linkage (and more typically a plurality of such linkages) as part of the resin backbone. A polyester resin often is derived from a mixture of reactants containing one or more polyols, preferably including at least dihydroxy and optionally trihydroxy polyols and one or more compounds comprising two or more co-reactive carboxylate functionalities, preferably including at least diacid and optionally triacid functionality. Suitable polyols that can be used to prepare polyesters resins include, but are not limited to ethylene glycol, diethylene glycol, triethylene glycol and higher polyethylene glycols, propylene glycol, dipropylene glycol, tripropylene glycol and higher polypropylene glycols, 1,3-propanediol, 1,4-butanediol and other butanediols, 1,5-pentanediol and other pentane diols, hexanediols, decanediols, and dodecanediols, glycerol, trimethylolpropane, neopentyl glycol, hexylene glycol, trimethylolethane, neopentyl glycol, pentaerythritol, dipentaerythritol, cyclohexanedimethanol, naphthalenediol, and mixtures thereof.

Exemplary acrylic binder resins include acrylic resins, vinyl-acrylic resins, styrene-acrylic resins, and the like resins. Useful acrylic resins are prepared through chain-growth polymerization using one or more ethylenically unsaturated monomers. Examples of suitable ethylenically unsaturated monomers include non-functional monomers such as styrene, halostyrenes, αmethylstyrene, alkyl esters of acrylic acid (e.g., methyl acrylate, ethyl acrylate, butyl acrylate, etc.), alkyl esters of methacrylic acid and/or crotonic acid (e.g., methyl, ethyl, propyl, butyl, pentyl, hexyl, octyl, decyl, dodecyl methacrylates and crotonates), vinyl cyclohexane, vinyl cyclooctane, vinyl cyclohexene, hexanediol diacrylate, dimethyl maleate, dibutyl fumarate and similar diesters, vinyl naphthalene, vinyl toluene, vinyl acetate, vinyl propionate, vinyl cyclooctane, ally methacrylate, 2-ethylhexyl acrylate, and diesters of maleic anhydride; and functional monomers such as acid-functional monomers (e.g., acrylic acid, methacrylic acid, crotonic acid, itaconic acid, maleic anhydride and esters thereof, mesaconic acid, citraconic acid, fumaric acid, and sorbic acid), amide-functional monomers (e.g., acrylamide, methacrylamide, etc.), hydroxy-functional monomers (e.g., hydroxyalkyl acrylate or methacrylate monomers such as hydroxyethyl acrylate (HEA), hydroxyethyl methacrylate (HEMA), hydroxypropyl acrylate (HPA), hydroxypropyl methacrylate (HPMA), etc.); and variations and combinations thereof.

Exemplary polyether or epoxy binder resins include polymers with an epoxy group or formed from a compound containing an epoxy group. The epoxy resin may be a linear epoxy resin with one or more terminal epoxy groups, although no epoxy groups need be present on the resin. The epoxy compound may be aliphatic or aromatic. Suitable epoxy compounds include aromatic compounds such as, for example, epoxy resins based on the diglycidyl ether of tetramethyl bisphenol F (“TMBPF-DGE”). Examples of suitable BPA-free polyether polymers are disclosed, for example, in U.S. Pat. No. 9,409,219 and International App. Publ. Nos. WO2013119686 and WO2021105970. Alternatively, any suitable difunctional compound (or mixture of compounds) capable of reacting with the oxirane groups may be employed. Examples of such compounds may include diacids such as, e.g., sebacic, adipic, azelaic, and dimer fatty acids (e.g., saturated and/or unsaturated dimer fatty acids, more preferably saturated); amines or diamines such as, e.g., butylamine, ethylenediamine, and hexamethylene diamine; amino acids such as, e.g., alanine, lysine, and aminododecanoic acid; diols (e.g., diphenols such as hydroquinone and tetramethyl bisphenol F); and mixtures and variations thereof.

Exemplary halogenated olefin binder resins may include halogenated polyolefins such as, for example polyvinylchloride. In other approaches, the halogenated polyolefins may include, for example, the oligomers, copolymers and homopolymers of vinyl chloride, vinylidenefluoride and its copolymers and homopolymers, polychloroprene, polychloroisoprene, polychlorobutylene, and combinations thereof.

Exemplary phenolic binder resins may include resins with two or more phenolic repeating units. In many instances, a phenolic resin is obtained by reacting one or more substituted or unsubstituted phenol reactants with one or more aldehydes. Examples of phenol reactants include phenol itself as well as substituted phenols. Illustrative substituted phenols often may be mono-substituted or di-substituted. If substituted phenols are used, these are preferably mono-substituted so that two sites remain for chain growth. Examples of substituted phenols include one or more of o-cresol, p-phenylphenol, p-tert-butylphenol, p-tert-amylphenol, cyclopentylphenol, p-tertoctyl phenol, bisphenol A (not preferred), resorcinol, hydroquinone, catechol, xylenol, cresylic acid, bisphenol-F (not preferred), combinations of these and the like. Derivatives of these reactants, such as etherified or acid functional derivatives, also may be used. Examples of aldehydes include one or more of formaldehyde, furfural, and for acetaldehyde. Phenolic resins may be either novolacs or resoles. A novolac resin is a phenolic resin in which an excess of phenolic reactant is used relative to aldehyde. A resole resin is a phenolic resin in which an excess of aldehyde is used relative to phenolic reactant. In preferred approaches, the coating compositions herein are formulated in a manner such that corresponding cured coatings are substantially free of, more preferably essentially free of, even more preferably essentially completely free of, are substantially free of each of bisphenol A, bisphenol F, and bisphenol S, including epoxides thereof.

In some embodiments, the coating composition is at least substantially free of bisphenol compounds, including epoxides thereof.

In some embodiments, the coating composition is “PVC-free.” That is, the powder coating composition preferably contains, if any, less than 2% by weight of vinyl chloride materials and other halogenated vinyl materials, more preferably less than 0.5% by weight of vinyl chloride materials and other halogenated vinyl materials, and even more preferably less than 1 ppm of vinyl chloride materials and other halogenated vinyl materials, if any.

As discussed more below in the Examples, a packaging container, or a portion thereof, having an interior surface thereof coated with the coating compositions herein, when dried and contacted with an aqueous test solution including 4 weight percent acetic acid, 0.5 weight percent sodium chloride, and 0.052 weight percent sodium metabisulfite and heated for 30 minutes at 100° C. and then stored at 35° C. for 7 weeks (while still contacting the aqueous test solution), exhibits one or more of the following (and preferably a plurality of, and more preferably all of) (i) the aqueous test solution has no more than 5 ppm of zinc from the inorganic sulfur-species scavenging component; (ii) the coating remains free of blistering; (iii) the coating exhibits a corrosion rating of 4 or less as defined herein; and/or (iv) the coating composition remains substantially white in color and/or has little color change (e.g., has a delta E of about 10 or less, about 5 or less, or about 1 or less) after baking conditions in contact with or without a gasket. As discussed herein, any corrosion performance evaluations are conducted on regular chromium passivated tin plate.

In some embodiments, the coating compositions herein, based on total nonvolatile weight, may include about 10 to about 25 weight percent polyester resin, about 0 to about 25 weight percent phenolic resin, about 0 to about 5 weight percent urea-formaldehyde resin, and about 0 to about 50 weight percent polyvinylchloride. The coating compositions may also include about 1 to about 25 weight percent of the composite particles. The coating compositions herein may include about 30 to about 50 weight percent of total solids.

### Optional Ingredients

If desired, the coating compositions may optionally include other additives that help to improve the manufacturability or use of the coating compositions or that help to improve the resultant coatings. Suitable optional additives include, for example, those that improve the processability or manufacturability of the composition, enhance composition aesthetics, or improve a particular functional property or characteristic of the coating composition or the cured composition resulting therefrom, such as adhesion to a substrate or adjacent composition. Additives that may be included are carriers, additional polymers, emulsifiers, pigments, metal powders or pastes, fillers, anti-migration aids, anti-microbials, extenders, curing agents, lubricants, coalescents, wetting agents, plasticizers, crosslinking agents, antifoaming agents, colorants, pigments, waxes, anti-oxidants, anticorrosion agents, flow control agents, thixotropic agents, dispersants, adhesion promoters, PVC stabilizers, scavenger agents or combinations thereof. Each optional ingredient can be included in a sufficient amount to serve its intended purpose, but preferably not in such an amount to adversely affect a coating composition or a cured coating resulting therefrom.

Exemplary crosslinkers used in a coating composition of the present disclosure include, but are not limited to, phenol-formaldehyde resins; amino-formaldehyde (also referred to as “aminoplasts”) resins including but not limited to urea-formaldehyde, melamine formaldehyde, benzoguanamine formaldehyde; anhydride resins, phenolic crosslinkers (e.g., phenoplasts), amino crosslinkers (e.g., aminoplasts), materials with blocked isocyanate functionality, materials with epoxy functionality including but not limited to (meth)acrylic resins or vinyl resins, carboxyl-reactive crosslinkers (e.g., β-hydroxyalkyl-amide crosslinkers such as the PRIMID XL-552 and PRIMID QM-1260 products from EMS-Griltech) or the like.

Blocked isocyanate crosslinking agents are suitable in many embodiments. A blocked isocyanate is a material including blocked isocyanate functionality that is unmasked upon heating to enable isocyanate crosslinking reactions. While the isocyanate functionality is blocked, the materials typically are stable and substantially non-reactive. If an NCO-functional material is provided in unblocked form, it is possible that the unblocked material may participate in crosslinking reactions sooner than might be desired, e.g., while a formulation is in storage for future use. The temperature at which the blocking is released can vary depending upon the type of blocked isocyanate being used. In many instances, blocking is released at temperatures in the range of 120° C. to 250° C., which conveniently is a suitable temperature range for carrying out crosslinking reactions in many modes of practice. Upon release of the blocking, the resulting polyisocyanates can react with other co-reactive functionality on resins to be crosslinked, such as carboxylate, hydroxyl or amine (primary or secondary) functionality to form amide, urethane or urea linkages.

Suitable embodiments of blocked isocyanates are compounds comprising cyclohexyl moieties such as a blocked isophorone diisocynate (IPDI). Linear, aliphatic blocked isocyanates also would be suitable in many modes of practice. One example of a linear, aliphatic blocked isocyanate is a blocked hexamethylene diisocyanate (HMDI). Aliphatic materials are preferred to avoid the generation of aromatic amines by hydrolysis. Blocked isocyanates in many instances are not pure dimers but are oligomers (isocyanurate, biuret, or similar structures) based on the dimer in order to help reduce vapor pressure.

Aminoplast crosslinkers are typically the condensation products of aldehydes such as formaldehyde, acetaldehyde, crotonaldehyde, and benzaldehyde with amino or amido group-containing substances such as urea, melamine, and benzoguanamine. Examples of suitable aminoplast crosslinking resins include benzoguanamine-formaldehyde resins, melamine-formaldehyde resins, esterified melamine-formaldehyde, and urea-formaldehyde resins. One specific example of a suitable aminoplast crosslinker is the fully alkylated melamine-formaldehyde resin commercially available from Cytec Industries, Inc. under the trade name of CYMEL 303.

One optional ingredient is a catalyst to increase the rate of crosslinking of the phenolic and/or other crosslinking resins. If used, a catalyst is preferably present in an amount of at least 0.05%, and more preferably at least 0.1%, by weight of nonvolatile material. If used, a catalyst is preferably present in an amount of at most 1%, and more preferably at most 0.5%, by weight of nonvolatile material.

Examples of catalysts, include, but are not limited to, strong acids (e.g., dodecylbenzene sulphonic acid (DDBSA, available as CYCAT 600), methane sulfonic acid (MSA), p-toluene sulfonic acid (PTSA), dinonylnaphthalene disulfonic acid (DNNDSA), and triflic acid), quaternary ammonium compounds, phosphorous compounds, zinc compounds, titanium catalysts, like a tetraalkyl ammonium halide, a tetraalkyl or tetraaryl phosphonium iodide or acetate, tin octoate, zinc octoate, triphenylphosphine, and similar catalysts known to persons skilled in the art.

Another useful optional ingredient is a lubricant, like a wax, such as waxes devoid of inorganic materials, which facilitates manufacture of metal closures or other fabricated (e.g., stamped) container parts by imparting lubricity to sheets of coated metal substrate. Waxes also may provide coatings with scratch resistance. A lubricant is preferably present in the coating composition in an amount of 0 to 4%, and preferably 0.1 to 2%, by weight of nonvolatile material. Examples of lubricants include carnauba wax, synthetic wax (e.g., Fischer-Tropsch wax), polytetrafluoroethylene (PTFE) wax, polyolefin wax (e.g., polyethylene (PE) wax, polypropylene (PP) wax, and high-density polyethylene (HDPE) wax), amide wax (e.g., micronized ethylene-bis-stearamide (EBS) wax), combinations thereof, and modified version thereof (e.g., amide-modified PE wax, PTFE-modified PE wax, and the like).

The coating compositions may incorporate one or more pigments. Examples include aluminum flake, and titanium dioxide, and combinations of these. If pigments are used, the resulting coating composition often may have a pigment-to-resin ratio of about 1:50 to 1:2, preferably 1:20 to 1:6, more preferably 1:15 to 1:6. The coating compositions may also include filers such as calcium carbonate or silica.

The removable closure of the disclosure also may include a gasket formed from a suitable sealing composition. The sealing composition is a material that is applied to at least a portion of the top or exposed surface of the coating for the purpose of assisting in sealing the closure to a container. Often the sealing composition is applied in an annular pattern to engage the top rim of a container when the closure is sealed thereon. Structurally, a preferred closure using a sealing composition on a closure of this disclosure would comprise a substrate, the coating systems formed from a coating composition of the present disclosure, and a gasket directly or indirectly on the coatings of the coating system.

Generally, sealing compositions are well known in the industry and any may be used. Some are solid components as applied. Others are fluids that chemically or physically cure to form solid gasketing material. As an example, a sealing composition may comprise at least about 10, more preferably at least about 25, and even more preferably at least about 30 wt-% of thermoplastic material, based on the total nonvolatile weight of the of the sealing composition. For non-solid sealing compositions, the sealing composition preferably includes less than about 60, more preferably less than about 55, and even more preferably less than about 50 weight percent (“wt-%”) of thermoplastic material, based on the total nonvolatile weight of the compound. As previously discussed herein, halogenated polyolefins such as PVC are commonly used thermoplastic materials in closure sealing compositions. In some instances, these polyolefins have high molecular weight, e.g., number average molecular weights over 20,000, even over 50,000. While not intending to be bound by any theory, in some embodiments, the incorporation of a suitable amount of thermoplastic material into the closure compound is believed to be important in achieving good compatibility and adhesion between a sealing composition and the coated closure.

Examples of useful sealing composition include, for example, PVC-containing sealing compositions (including, e.g., plastisols) for sealing closures to food or beverage containers. In some embodiments, the sealing composition may contain a polypropylene additive. Preferred sealing compositions are at least substantially free of each of bisphenol A, F, and S, including diepoxides thereof.

The total film thickness of the cured coating systems of the present invention may vary depending upon a variety of factors, including, for example, the desired properties (e.g., mechanical properties, aesthetic properties, corrosion resistance, etc.) of the cured coating system, the substrate upon which the coating system is applied, the presence of substances that may contact the cured coating system (e.g., certain aggressive or corrosive products), and/or the intended use of the coated article. In presently preferred embodiments, the total dry film weight of a coating in the coating systems herein is at least about 0.2, more preferably at least about 2, and even more preferably at least about 5 g/m² (grams per square meter or gsm). Preferably, the total dry film weight of a cured coating (not including any sealing composition that may be present) is less than about 30 g/m², more preferably less than about 25 g/m², and even more preferably less than about 20 g/m².

Preferably, the coating composition of the present disclosure comprises a liquid carrier. Although aqueous carrier liquids can be used in certain embodiments, the carrier liquid is typically at least substantially non-aqueous). While not preferred, in some embodiments a relatively low amount of water may be included so long as the coating composition is not unsuitably affected. In illustrative embodiments, the liquid carrier includes less than 2 weight percent water, if any, based on the total weight of the liquid carrier.

Examples of suitable liquid carriers include an organic solvent, a plasticizer, or mixtures thereof. Suitable organic solvents include, for example, aliphatic hydrocarbons, like mineral spirits, and high flash VM & P naphtha; aromatic hydrocarbons, like toluene, xylene and blends thereof (e.g., the Aromatic Solvent 100 product); alcohols, like isopropyl alcohol, n-butyl alcohol, and ethyl alcohol; ketones, like cyclohexanone, ethyl aryl ketones, methyl aryl ketones, and methyl isoamyl ketone; esters, like alkyl acetates (e.g. ethyl acetate and butyl acetate); glycol ethers like ethylene glycol monomethyl ether, ethylene glycol monoethyl ether, ethylene glycol monobutyl ether, and propylene glycol monomethyl ether; glycol ether esters, like propylene glycol monomethyl ether acetate; aprotic solvents, like tetrahydrofuran; mixtures of these solvents and the like. Preferred liquid carriers have sufficient volatility to evaporate substantially from the coating system during the curing process.

Examples of suitable plasticizers include phosphates, adipates, sebacates, epoxidized oils (not preferred, but may be used in certain embodiments if desired), polyesters, and combinations thereof.

Coating compositions for use in the present coating system can be prepared using any suitable method to preferably provide sufficient suspension and dispersion of the components included therein. Examples of suitable process methods include solution blending, high-speed dispersion, high-speed milling, and the like. A substantially homogeneous dispersion of the components throughout a liquid carrier typically indicates an adequate mixture or blend.

Preferably, the cured systems are retortable when used in food and beverage container applications. Preferred cured coatings of the present invention can withstand elevated temperature conditions frequently associated with retort processes or other food or beverage preservation or sterilization processes. As discussed above, particularly preferred cured coating systems exhibit enhanced resistance to such conditions while in contact with food or beverage products that exhibit one or more aggressive (or corrosive) chemical properties under such conditions and/or sulfur containing food or beverage products.

The coating system of the present disclosure can be applied to a substrate using any suitable procedure such as, for example, spray coating, roll coating, coil coating, curtain coating, immersion coating, meniscus coating, kiss coating, blade coating, knife coating, dip coating, slot coating, slide coating, and the like, as well as other types of pre-metered coating. In one embodiment where the coating is used to coat metal sheets or coils, the coating can be applied by roll coating.

The coating system can be applied to a substrate prior to, or after, forming the substrate into a closure, and typically applied before so that the coated substrate can be formed into a closure. Preferably, at least a portion of the substrate is coated with the coating system of the present disclosure, which is then at least partially cured before the substrate is formed into an article or closure. In one presently preferred embodiment, the following method is used: (1) the coating composition is applied to at least a portion of the substrate, (2) the coating composition is at least partially cured, (3) the coated substrate is shaped to form a closure (e.g., via stamping), (4) the coating is more completely cured if applicable; and (5) a sealing composition is then applied to the cured coating to help provide a gasket for sealing the closure to its corresponding container. Optionally, the further curing of step (4) can be practiced concurrently with and/or after step (5)

Coating systems of the present disclosure are preferably cured to form a hardened coating system. After applying the coating system onto a substrate, the coating compositions of the present disclosure can be cured using a variety of processes, including, for example, oven baking by either conventional or convectional methods, or any other method that provides an elevated temperature. The curing process may be performed in either discrete or combined steps. For example, substrates can be dried at ambient temperature to leave the coating compositions in a largely un-crosslinked state. The coated substrates can then be heated to more fully cure the compositions. In certain instances, coating compositions can be dried and cured in one step.

The curing process for any individual layer or coating of the closures or other substrates may be performed at temperatures in the range of about 177° C. to about 232° C. for about 5 seconds to 1 hour, more typically about 2 minutes to about 30 minutes, and more typically about 3 minutes to about 10 minutes, taking into account, however that the upper end of the temperature range can change depending on the decomposition temperature(s) of the coating constituents

The coating compositions may be used in mono-coat or multilayer systems, such as a two-coat system having a base coat and a top coat. If a multilayer system, the binders and composite particles herein may be provided in any of the layers of the system or all of the layers of the system. In approaches, any layer of a mono-coat and/or multi-layer system herein (i.e., the first, second, or both layers), when dried, may include, up to about 10 weight percent of the metal oxide, up to about 8 weight percent of the metal oxide, up to about 6 weight percent, or even up to about 4 weight percent of the metal oxide and preferably, about 0.01 to about 10 weight percent of the metal oxide or other ranges within the above noted amounts, and more preferably, about 0.1 to about 5 weight percent as measured on a non-volatile portion of the coating composition of the layer. In other approaches, when the inorganic material is a metal oxide, any layer of the mono-coat and/or the multi-layer system herein (i.e., the first, second, or both layers), when dried, may include metal provided by the metal oxide. As noted, the metal may be enriched at the interface and/or surface regions of any coating layer.

As already discussed above, the composite particles may be included in one or more layers of a multi-layer coating system. Examples of such multi-layer systems include interior closure coating systems or food-easy-open can end interior coating systems such as those described, for example, in U.S. Pat. Nos. 8,142,858, 8,574,672, 10,516,502, U.S. Publ. No. 2016/0221733, and U.S. Publ. No. 2017/0137665. In such systems, typically the base layer (often referred to as a “size” or “primer” coat) is a polyester-based or polyether-based coating, and typically including one or more crosslinkers disclosed herein such as a phenolic crosslinker. The top-coat layer is often a PVC organosol that typically includes a thermoplastic polyvinyl chloride (PVC) polymer, one or more stabilizers (for the PVC such as, e.g., an oxirane-functional acrylic resin), and one or more crosslinkers (e.g., phenolic crosslinkers), and optionally one or more other binder polymers (e.g., acrylics, polyesters, and the like). In some embodiments, the composite particles are included in a mono-layer closure coating system. An example of such a closure coating system is described in U.S. Pat. No. 10,486,865, which describes embodiments that are substantially free of polyvinyl chloride. An example of a mono-layer PVC organosol is described in U.S. Pat. No. 7,682,674.

### Removable Closure

The coating compositions herein are especially useful for use on the interior surface, or at least a portion thereof, of removable or screw-type closures, such as those meant to seal the opening of a variety of containers or bottles as detailed above. In many embodiments, the closures are removable from and, optionally, replaceable onto the container. Examples of such removable closures include twist-off closures for food packages, including cans, bottles, etc., and single use containers such as the pull off closures on beverage containers, etc. The coating compositions protect the coated substrate against staining (e.g., yellowing or black spots), corrosion, moisture damage, acid damage, alkaline damage, and/or other chemical or physical damage such as damage caused by the contents of the container. They also impart coating hardness. Many embodiments would be suitable for prolonged food and beverage contact, making corresponding coatings useful for protecting food and beverage containers. Additionally, the coating compositions herein exhibit excellent substrate, inter-layer (if any), and gasket adhesion. The coating compositions also demonstrate a balance of flexibility and hardness that allows them to be applied to a substrate sheet (e.g., a metal sheet). After coating, the coated sheet may then be formed into a desired shape (e.g., via stamping), such as a twist-off closure, without undue loss (if any) of adhesion to sheet or a loss of inter-layer adhesion. The coating compositions herein are particularly suited for providing corrosion resistance to chromium-free metal substrates, but may be used on other metal substrates as well depending on the application.

The removable closure is fabricated, as already discussed above, from a hexavalent chromium-free metal substrate or, alternatively, a chromium-treated metal substrate having an interior and an exterior surface with one or more coatings as described herein applied on at least a portion of the interior surface of the substrate.

The coating(s) for the removable closure is derived from the coating compositions as described above including ingredients comprising the one or more above-described film-forming binder resins and the above-described composite particles of an inorganic substance (such as a metal oxide) encapsulated in an organic carrier matrix. The applied coating may be a coating system including a single layer or multilayers (such as a first and second layer of the above-described coating compositions). In one approach, the removable closure includes a first and second coating of the coating composition herein applied to at least a portion of the interior surface of the substrate and wherein any embodiment of the coating composition described above is provided in either the first coating, the second coating, or both the first and second coating.

The coating systems herein of the first, second, or both layers having the composite particles in one or more of the first, second, or both layers protect the metal substrates of the removable closures, particularly chromium-free metal substrates, against reacting with food or beverage components, liquid chemicals, other components of a liquid coating composition, or elements of a food or the beverage.

In embodiments, removable closures and/or hexavalent chromium-free substrates thereof and with the coating systems herein, when exposed to a test food simulant having about 95% water, about 4% acetic acid, about 0.5 weight percent sodium chloride, and about 0.05% sodium thiosulfate and then autoclaved for 30 minutes at 100° C. and placed in an oven at 35° C. for at least 3 weeks, have little to no corrosion, discoloration, and/or surface bubbling as further demonstrated in the Examples below. Corrosion ratings may be defined by those in Table 1 below and such closures of the present disclosure having a first coating of about 8 to about 9 gsm (applied to the substrate) and a second coating of about 8 to about 9 gsm (applied to the first coating) with the coatings including the binders and composite particles herein in either the first, second, or both coatings (each coating baked at 200° C. for 12 minutes) and, when subjected to the test food simulant described above and stored at 35° C. for at least 3 weeks have a corrosion level of about 4 or less, about 3 or less, about 2 or less, about 1, or 0. Such corrosion levels are achieved on both chromium-free and chromium-treated substrates.

TABLE 1
corrosion ratings.

| Corrosion | | |
|---|---|---|
| Level | Rating | Description |
| Very | 8-10 | Bubbles on the whole flat area, corrosion points, |
| advanced | | blackening |
| Advanced | 5-7 | Some corrosion points, presence of bubbles on a |
| | | large part of the flat area |
| Some | 2-4 | Few corrosion points or bubbles, either on the |
| | | flat area or at the featheredge |
| No corrosion | 0-1 | No corrosion at all, no bubble, no corrosion point |

In embodiments, exemplary coating compositions for the coating systems herein include those of Table 2 below describing general and preferred compositions for a topcoat and/or a sizecoat for removable closures.

TABLE 2
Exemplary Compositions for First and/or
Second Layers for a Removable Closure

| | Topcoat | Topcoat | Sizecoat | Sizecoat |
|---|---|---|---|---|
| | General | Preferred | General | Preferred |
| | (wt %) | (wt %) | (wt %) | (wt %) |
| Polyester resin | 20-70 | 20-70 | 10-30 | 10-30 |
| Phenolic resin | 0-20 | 2-20 | 0-25 | 15-20 |
| Urea-formaldehyde resin | 0-5 | 0.5-3 | 0-5 | 0.5-3 |
| Acrylic Resin | 0-5 | 0.5-3 | 0-5 | 0.5-3 |
| Polyolefin Resin | 0-5 | 0.5-3 | 0-5 | 0.5-3 |
| Epoxy Resin | 0-5 | 0.5-3 | 0-5 | 0.5-3 |
| TiO₂ | 10-20 | 0.5-3 | 2-15 | 0.5-3 |
| PVC | 0-50 | 20-50 | 0-50 | 20-50 |
| Polyolefin wax | 0-5 | 2-5 | 0-5 | 2-5 |
| Blocked isocyanate | 0-5 | 1-4 | 0-5 | 1-4 |
| Silicone anti foam | 0-1 | 0.02-0.5 | 0-1 | 0.02-0.5 |
| Solvent mixture | 10-60 | 5-20 | 10-60 | 40-60 |
| Composite Particles | 1-20 | 1-20 | 1-20 | 1-20 |
| Total | 100 | 100 | 100 | 100 |

### EXAMPLES

The following examples are illustrative of exemplary embodiments of the disclosure. In these examples, as well as elsewhere in this application, all ratios, parts, and percentages are by weight unless otherwise indicated. It is intended that these examples are being presented for the purpose of illustration only and are not intended to limit the scope of the invention disclosed herein. The following examples evaluate corrosion on closures coated with two-coat coating systems and, in some instances, retorted and/or exposed to a food simulant for prolonged periods of time.

### Example 1

Composite particles of zinc oxide and wax were prepared by vigorously mixing the zinc oxide through the various wax materials denoted as Z1 to Z3 as described in Table 3 below.

TABLE 3
Composite Particles

| | | Melting Point | % | Specific area |
|---|---|---|---|---|
| Sample | Wax | of Wax (° C.) | ZnO | ZnO (m²/g) |
| Z1 | Polyester composition | — | 33.4 | 3-4 |
| Z2 | Rice bran wax | — | 80 | 5-7 |
| Z3 | Polyamide wax | — | 70 | 3-4 |

For composite particle Z1, the zinc oxide was dispersed in a solvent-soluble polyester composition that was fully soluble in the finished coating compositions of the subsequent Examples. Thus, for composite particle Z1, the zinc oxide was expected to be brought in direct contact with coating ingredients and/or the tested food simulant because the wax was not expected to provide coverage or protection to the zinc oxide. In all other composite particles (Z2 and Z3), the wax was substantially insoluble in the finished coating to shield and/or protect the zinc oxide from coating ingredients and food simulants.

### Example 2

Coating compositions C1 to C13 were prepared by mixing base Formulas F1 to F4 of Table 4 with zinc oxide composite particles Z1-Z3 of Example 1 as shown in Tables 5 below.

TABLE 4
Base Formula (Percentage)

| | Topcoat | Topcoat | Sizecoat | Topcoat |
|---|---|---|---|---|
| | F1 | F2 | F3 | F4 |
| Polyester resin | 22.1% | 63.0% | 23.8% | 24.6% |
| TiO₂ | 15.9% | 21.2% | 5.9% | 11.8% |
| PVC | 40.7% | — | — | — |
| Polyolefin wax | 1.0% | 2.1% | — | 2.2% |
| Phenolic resin | 4.5% | — | 18.5% | 11.2% |
| Blocked isocyanate | — | 3.3% | — | 1.0% |
| Urea-formaldehyde resin | — | 1.1% | — | — |
| Silicone anti foam | — | — | — | 0.1% |
| Solvent mixture | 15.8% | 9.2% | 51.8% | 49.1% |

TABLE 5
Coating Composition (Weight Parts)

| | | | | | | | | Equivalent |
|---|---|---|---|---|---|---|---|---|
| | | | | | | | | ZnO |
| | Base Formula F | | | | Composite Particle | | | concen- |
| Coating | F1 | F2 | F3 | F4 | Z1 | Z2 | Z3 | tration |
| C1 | 100 | — | — | — | — | 1.0 | — | 0.79% |
| C2 | 100 | — | — | — | — | — | 1.0 | 0.69% |
| C3 | — | 100 | — | — | — | 1.0 | — | 0.79% |
| C4 | — | 100 | — | — | — | — | 1.1 | 0.79% |
| C5 | — | — | 100 | — | — | 3.0 | — | 2.30% |
| C6 | — | — | 100 | — | — | — | 3.4 | 2.30% |
| C7 | — | — | 100 | — | — | — | 1.1 | 0.79% |
| C8 | — | — | — | 99.7 | — | 0.3 | — | 0.24% |
| C9 | — | — | — | 97 | — | 3.0 | — | 2.40% |
| C10 | — | — | 99.7 | — | — | 0.3 | — | 0.24% |
| C11 | 97 | — | — | — | — | 3.0 | — | 2.40% |
| C12 | — | — | 91.5 | — | 8.5 | — | — | 2.84% |
| C13 | 91.5 | — | — | — | 8.5 | — | — | 2.84% |

### Example 3

Liquid coating compositions from Example 2 were applied onto metal substrate panels of Table 6 using a two-layer coating system as described in Table 7 below. A first coating or layer 1 was applied directly to the metal substrate in amounts to achieve a dry film weight of about 8 to 8.5 grams per square meter (“gms”) after baking in an electric oven at an oven temperature of about 200° C. for about 12 minutes. A second coating or “second layer” was then applied over the first coating in amounts to achieve a dry film weight of 7.5 to 8.5 gms after baking in an electric oven at an oven temperature of about 190° C. for a about 12 minutes, thereby forming the multi-layer coating systems as identified in Table 7 below.

TABLE 6
Metal Substrate

| | Substrate - M1 | Substrate - M2 |
|---|---|---|
| Passivation | Chromium - P311 | CFPA - 555 |
| Temper | TH 620 | TH 620 |
| Metal thickness | 0.14 | 0.14 |
| Tin gauge | 2.0/2.0 | 2.0/2.0 |
| Supplier | ArcelorMittal | TK Rasselstein |

TABLE 7
Coating Systems

| | Layers | | | | |
|---|---|---|---|---|---|
| | 1st layer | 2nd layer | Composite Particles | Location of Composite | |
| System | composition | composition | with Zinc Oxide | Particles | Comments |
| S1 | F3 | F1 | No | None | Control - no zinc |
| | | | | | oxide |
| S2 | F3 | C1 | Yes | Second Layer | |
| S3 | C5 | C1 | Yes | First and Second layer | |
| S4 | F3 | C2 | Yes | Second Layer | |
| S5 | C6 | C2 | Yes | First and Second Layer | |
| S6 | F3 | F2 | No | None | Control - no zinc |
| | | | | | oxide |
| S7 | F3 | C3 | Yes | Second Layer | |
| S8 | C5 | C3 | Yes | First and Second Layer | |
| S9 | F3 | C4 | Yes | Second Layer | |
| S10 | C6 | C4 | Yes | First and Second Layer | |
| S11 | C7 | F1 | Yes | First Layer | |
| S12 | C6 | F1 | Yes | First Layer | |
| S13 | C6 | F2 | Yes | First Layer | |
| S14 | F3 | F4 | No | None | Control - no Zinc |
| | | | | | oxide |
| S15 | C10 | C8 | Yes | First and Second Layer | |
| S16 | C5 | C9 | Yes | First and Second Layer | |
| S17 | C5 | C11 | Yes | First and Second Layer | |
| S18 | C12 | C13 | Yes | First and Second layer | Control - Polyester |
| | | | | | Composite Matrix |

The coated substrates S1 to S18 were then converted into closures with the two-layer coating systems applied to the internal side of the closure. The formed closures included a groove into which a PVC-based compound (plastisol) was deposited and baked in place to form a gasket. The produced closures were then used to cap glass jars filled with a test food simulant having about 95 weight percent water, about 4 weight percent acetic acid, 0.5 weight percent sodium chloride and 0.052 weight percent sodium metabisulfite. The test jars were then autoclaved for about 30 minutes at about 100° C. and placed in incubator ovens at about 35° C. for several weeks as indicated in each further Example below. After the set incubation time, some of the test jars are opened, and advancement of corrosion estimated by visual inspection of the inner side of the cap. Results are reported using the corrosion rating scale of Table 8

TABLE 8
Visual Corrosion Scale

| Corrosion Level | Rating | Description |
|---|---|---|
| Very advanced | 8-10 | Bubbles on the whole flat area, corrosion points, blackening |
| Advanced | 5-7 | Some corrosion points, presence of bubbles on a large part of the flat area |
| Some | 2-4 | Few corrosion points or bubbles, either on the flat area or at the featheredge |
| None | 0-1 | No corrosion at all, no bubble, no corrosion point |

### Example 4

This Example evaluates the protection effect of composite particles of zinc oxide in a wax compared to a polyester wax. In this Example, control coating system S18 (zinc oxide embedded within a polyester wax) was compared to coating system S17 (zinc oxide embedded within a rice bran wax). This comparison shows how zinc oxide within the wax, which is not soluble in the compositions of the various coating systems, effectively prevents PVC from the coating composition and/or gasket from being thermally degraded. The systems in this Example were cast on test panels and then baked once at about 200° C. for about 12 minutes. The coated panels were then submitted to additional bake cycles as shown in Table 9 below and the noted differences in color and properties alterations related to the extent of thermal degradation of the coating.

TABLE 9

| System | S18 | S17 |
|---|---|---|
| Dry % of ZnO in each coat | 2.84% | 2.40% |
| After 1 overbake | Blackening of the entire coating, | Buff color and area where the coating was in excess |
| | and coating peeled off | became black / and/or smoky. |
| After 2 overbakes | Not further tested | Buff color and visual detection of some black |
| | | corrosion spots on the metal sheet through the |
| | | coating |
| After 3 overbakes | Not further tested | Slight darkening with a smoky aspect in some areas |
| | | and an Increase of the number of black spots |

In this evaluation, the zinc oxide composite particles were included in both the first and second layers of each coating systems. The second layer in each sample also included PVC as a component, which tends to release hydrogen chloride upon baking. This Example shows that embedding zinc oxide in a wax (i.e., coating system S17) dramatically reduces the damaging effect of hydrogen chloride released from the PVC and further shows that the zinc oxide was effectively shielded from the PVC as compared to composite particles made with a polyester carrier. Control coating system S18 produced poor results after only 1 bake and was not further evaluated.

### Example 5

This study investigated the impact of wax on corrosion ratings and zinc salt migration to the food simulant. In this Example, various coating systems from Example 3 were applied to Substrate M2 of Table 6, formed into a closure, sealed to a container including the food simulate of Example 3 and stored for the time periods noted in Table 10 below. Corrosion rating pursuant to the scale of Table 10 were observed a shown below.

TABLE 10
Corrosion ratings

| Storage time (weeks) | S6 | S8 | S10 |
|---|---|---|---|
| 3 | 9 | 4 | 2 |
| 7 | 10 | 7 | 4 |

In this study, coating system S6 was a control with no zinc oxide composite particles, coating system S8 included zinc oxide composite parties in both layers of the two-layer coating system with a rice bran wax, and coating system S10 include zinc oxide composite particles in both layers of the two-layer coating system with a polyamide wax. The PVC-free coating systems of this Example, when applied to a chromium-free substrate (M2) showed substantially improved corrosion resistance (i.e., lower corrosion rating) by addition of composite zinc oxide particles (Samples S8 and S10), whether after 3 or 7 weeks storage at 35° C., and despite the absence of phenolic resins in the topcoat as compared to control sample S6 without any zinc oxide bearing composite particles. The corrosion resistance is also substantially higher in Sample S10 that included the composite particles of zinc oxide embedded in higher melting temperature wax.

In this example, the liquid simulant used to expose coated caps to a corrosive environment was also analyzed for zinc contents as shown in Table 11 below. After the noted storage period, the liquid simulant was filtrated on 0.45 μm regenerated cellulose filter and then analyzed by ICP/OES for zinc ions. Three or four repeats were analyzed per sample and averaged. The average was calculated with 3 specific wavelengths of zinc and reported in ppm (mg/L). The quantification limit was 0.1 ppm (mg/L).

TABLE 11
Zn salts migration within the simulant (ppm)

| ZnO compound | — | Z2 | Z3 |
|---|---|---|---|
| Storage time (weeks) | S6 | S8 | S10 |
| 3 | <0.1 | 2.4 | 0.9 |
| 7 | <0.1 | 2.6 | 1.2 |

As shown in Table 11, the addition of composite zinc oxide particles leads, in some instances, to migration of zinc and/or zinc salts to the food simulants after a 3- or 7-week storage at 35° C. However, in each case, zinc migrations remained well below the specific migration limits (SML) for zinc ions at 5 ppm. However, migrations are lower for the composite particle having zinc oxide composite particles Z3 featuring the polyamide wax, which had a higher melting point and least soluble wax as compared to the rice bran wax.

### Example 6

A study was performed to evaluate the impact of various zinc oxide concentrations in each layer of a two-part coating system based on corrosion ratings. The food simulant of Example 3 was used and the coatings were applied to the M1 substrate of Example 3 and stored at 35° C. for the noted time intervals.

TABLE 12
Corrosion Resistance Rating by Coating System

| Storage time (weeks) | S14 | S15 | S16 |
|---|---|---|---|
| 3 | 5 | 0 | 0 |
| 7 | 7 | 6 | 1 |

Coating system S14 was a control having no zinc oxide composite particles in either layer. Coating system S15 includes about 0.24% zinc oxide in each layer, and coating system S15 included 2.3% to about 2.4% zinc oxide in each layer. This example shows that the addition of an increased and equal amount of zinc oxide composite particles to both layers of a PVC-free and two-coat system substantially improves its corrosion resistance on chromium-passivated tinplate.

### Example 7

In this Example, the impact of different zinc oxide concentration in each layer of a two-layer coating system was evaluated based on corrosion ratings. The food simulant of Example 3 was used and the coatings were applied to the M2 substrate of Example 3 and stored at 35° C. for the noted time intervals.

TABLE 13
Corrosion ratings

| Storage time (weeks) | S6 | S9 | S10 |
|---|---|---|---|
| 3 | 9 | 7 | 2 |

Coating system S6 was a control with no zinc oxide composite particles in either layer. Coating system S9 had no zinc oxide in the first layer, but 0.79% zinc oxide in the second layer. Coating system S10 had about 2.3% zinc oxide in the first layer and 0.79% zinc oxide in the second layer. Thus, addition of a different quantities of zinc oxide composite particles in the first and in the second layer (i.e., system S10) improved the system's corrosion resistance on chromium-free substrate.

### Example 8

This Example evaluates the impact of zinc oxide added only to the first coat of a two-layer coating system based on corrosion ratings. As in the previous Example, the food simulant of Example 3 was used and the coatings were applied to the M2 substrate of Example 3 and stored at 35° C. for the noted time intervals.

TABLE 14
Corrosion Resistance Rating by Coating System

| Storage time (weeks) | S6 | S11 | S12 |
|---|---|---|---|
| 3 | 9 | 8 | 5 |

Coating system S6 was a control with no zinc oxide composite particles, coating system S11 includes no zine oxide particles in the first layer, but 0.79% zinc from zinc oxide composite particles in the second layer, and coating system S12 includes zinc oxide composite particles in both layers with about 2.3% zinc oxide in the first layer and about 0.79% zinc oxide in the second layer. As shown in the Table above, corrosion resistance on chromium-free metal significantly improves as the addition of zinc oxide composite particles in the first layer increases (i.e., S12).

### Example 9

This Example compares the impact of zinc oxide on corrosion on both substrate passivations of metals M1 and M2 of Example 3 in containers of the food simulant of Example 3 when stored at 35° C. Corrosion resistance on chrome-free passivation or CFPA (M2 substrate) is substantially improved by addition of zinc oxide composite particles. This example evaluated coating system S6 (a control having no zinc oxide composite particles) and coating system S10 (zinc oxide composite particles in both layers).

TABLE 15
Corrosion Resistance Rating by Coating System

| | M1 | M1 | M2 | M2 |
|---|---|---|---|---|
| Storage time (weeks) | S6 | S10 | S6 | S10 |
| 6 | 0 | 0 | 10 | 3 |

### Example 10

This Example evaluates the impact of PVC in the coating compositions on the effectiveness of zinc oxide composite particles. For this study, the food simulant of Example 3 was used and the coating systems were applied to substrate M1 of Example 3 and stored at 35° C. for the noted time.

TABLE 16
Corrosion Resistance Rating by Coating System

| Storage time (weeks) | S14 | S16 | S1 | S17 |
|---|---|---|---|---|
| 7 | 7 | 1 | 9 | 5 |

Coating system S14 was a control with no PVC in any coating layer and no zinc oxide composite particles. Coating system S16 includes no PVC in either coating layer, but zinc oxide composite particles in both layers. Coating system S1 was a control with no zinc oxide composite particles, but PVC within the composition used in the second layer. Lastly, coating system S17 included PVC within the compositions forming the second layer and zinc oxide composite particles in both layers of the coating system. The corrosion ratings of Table 16 above show that composite particles with zinc oxide acts as a more effective corrosion inhibitor on both metal passivations when added to a coating containing no PVC than to a coating containing PVC.

### Example 11

This study evaluated the addition of zinc oxide in either or both coating layers of a two-layer coating system when applied to the M2 substrate of Example 3. The evaluation used the food simulant of Example 3 and stored the samples at 35° C. for the noted times below.

TABLE 17
Corrosion Resistance Rating by Coating System

| Storage time (weeks) | S6 | S9 | S13 | S10 |
|---|---|---|---|---|
| 7 | 9 | 8 | 4 | 1 |

Coating system S6 was a control having no zinc oxide composite particles. Coating system S9 included zinc composite particles in the second layer, coating system S13 included zinc oxide composite particles in the first layer, and coating system S10 included zinc oxide composite particles in both layers. In PVC-free coating systems of this Example and when applied to hexavalent chromium-free metal substrates, the addition of composite particles of zinc oxide in both layers of the coating system (i.e., S10) improves corrosion protection as compared to adding the zinc oxide in the first or second layers or compared to samples without zinc oxide.

All patents, patent applications, and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A packaging container, or a portion thereof, comprising:
a metal substrate; and
an interior coating applied on at least a portion of the metal substrate, the interior coating formed from a coating composition including one or more film-forming binder resins and composite particles comprising one or more waxes and one or more inorganic sulfur-species scavenging component.

2. (canceled)

3. The packaging container, or a portion thereof, of claim 1, wherein the inorganic sulfur-species scavenging component includes a zinc oxide, a zinc aluminate, a zinc titanate, or a combination thereof, and preferably, includes a zinc oxide.

4. (canceled)

5. The packaging container, or a portion thereof, of claim 1, wherein the wax has a solubility in water at 25° C. of less than 10 mg/liter, or wherein the wax has a solubility in xylene at 50° C. of less than 1 g/liter.

6. (canceled)

7. The packaging container, or portion thereof, of claim 1, wherein the inorganic sulfur-species scavenging component has a solubility in water at a pH of 2 and at 25° C. of greater than 1 mg/liter.

8. The packaging container, or a portion thereof, of claim 1, wherein the metal substrate includes a metal substrate that has not been passivated using a hexavalent chromium containing composition and wherein the metal substrate is pretreated with a pretreatment composition comprising a zirconium compound and one or more optional polymers.

9. (canceled)

10. (canceled)

11. (canceled)

12. (canceled)

13. The packaging container, or a portion thereof, of claim 1, wherein the wax is selected from (i) esters of fatty acids with fatty alcohols, fatty aldehydes, fatty triterpene alcohols, fatty steroid alcohols, or mixtures thereof; (ii) polyolefin waxes, (iii) fatty amides; (iv) metal esters of fatty acids; (v) derivatives thereof, or (vi) mixtures thereof.

14. The packaging container, or portion thereof, of claim 13, wherein the molecules forming the wax have 16 or more carbons and wherein the wax has a drop melting point of 60° C. to 250° C. as measured by ASTM D127.

15. (canceled)

16. (canceled)

17. (canceled)

18. The packaging container, or a portion thereof, of claim 1, wherein the inorganic sulfur-species scavenging component has a distribution of particle sizes greater than 100 nm and about 2 microns or less.

19. (canceled)

20. The packaging container, or a portion thereof, of claim 1, wherein the inorganic sulfur-species scavenging component has a surface area of at least about 1 m²/g as determined by ASTM D3037.

21. The packaging container, or a portion thereof, of claim 1, wherein the composite particles have a particle size ranging from a D10 at least about 0.3 microns to a D90 of about 10 microns or less.

22. (canceled)

23. The packaging container, or a portion thereof, of claim 1, wherein the composite particles include at least about 30 weight percent of the inorganic sulfur-species scavenging component based on the total weight of the composite particles, and wherein the composite particles include about 90 weight percent or less of the inorganic sulfur-species scavenging component based on the total weight of the composite particles.

24. (canceled)

25. The packaging container, or a portion thereof, of claim 23, wherein the composite particles include at least about 10 weight percent of wax based on the total weight of the composite particles and wherein the composite particles include about 70 weight percent or less of wax based on the total weight of the composite particles.

26. (canceled)

27. The packaging container, or a portion thereof, of claim 3, wherein the coating composition has a weight ratio of zinc to an amount of the composite particle of about 40% to about 80%.

28. (canceled)

29. The packaging container, or a portion thereof, of claim 1, wherein the coating composition, when dried as a coating on the interior surface of the substrate, has about 10 weight percent or less of the inorganic sulfur-species scavenging component.

30. (canceled)

31. (canceled)

32. The packaging container, or a portion thereof, of claim 1, further including a first and a second coating applied to at least a portion of the interior surface of the substrate and wherein the coating composition is either the first coating, the second coating, or both the first and the second coating and wherein one of the first coating, the second coating or both has a concentration of composite particles within a surface region of the respective dried coating greater than a concentration of composite particles within a central region of the respective dried coating.

33. (canceled)

34. (canceled)

35. The packaging container, or portion thereof, of claim 32, wherein the second layer is a PVC organosol including a thermoplastic polyvinyl chloride (PVC) polymer, one or more stabilizers (for the PVC), and one or more crosslinkers, and optionally one or more other binder polymers.

36. The packaging container, or a portion thereof, of claim 1, further including a sealing gasket and wherein the sealing gasket is a polyvinylchloride-containing sealing gasket.

37. (canceled)

38. The packaging container, or a portion thereof, of claim 1, wherein the composite particles remain as a discrete particle within the interior coating after all thermal treatments.

39. (canceled)

40. (canceled)

41. (canceled)

42. (canceled)

43. The packaging container, or a portion thereof, of claim 1, wherein the coating composition, based on total nonvolatile weight, includes about 10 to about 20 weight percent polyester resin, about 0 to about 25 weight percent phenolic resin, about 0 to about 5 weight percent urea-formaldehyde resin, about 0 to about 50 weight percent polyvinylchloride, and about 1 to about 20 weight percent of the composite particles.

44. (canceled)

45. (canceled)

46. (canceled)

47. (canceled)

48. The packaging container or portion thereof of claim 1, wherein the packaging container or portion thereof, comprises a food or beverage can, or a food or beverage can end, or both.

49. (canceled)

50. The coating composition of claim 1.
